(19) United States
(12) Patent Application Publication
(10) Pub. No.: US 2008/0149894 A1
(43) Pub. Date: Jun. 26, 2008

(54) Red fluorescent inks for bar code printing

(76) Inventors: Judith D. Auslander, Westport, CT (US); Richard A. Bernard, Norwalk, CT (US); Shunichi Higashiyama, Yokkaichi-shi (JP); Michiko Aoyama, Nagoya-shi (JP)

Correspondence Address: PITNEY BOWES INC.;35 WATERVIEW DRIVE, P.O. BOX 3000, MSC 26-22, SHELTON, CT, 06484-8000, US

(21) Appl. No.: 11/644,532

(22) Filed: Dec. 22, 2006

(51) Int. Cl. C09K 11/06; B41J 2/01

(52) U.S. Cl. 252/301.16; 106/31.32; 347/1

(57) ABSTRACT

New ink-jet printing inks provide red printed images with high-intensity fluorescence emission and are capable of printing images that can be used for high density bar code applications (2D bar codes) having high readability. The inks are aqueous and capable of producing machine-readable markings exhibiting fluorescence when exposed to fluorescent-exciting radiation. They exhibit a peak of fluorescence between about 500 nm and about 700 nm and a fluorescent strength of the ink diluted by 100 times of more than about 70 by excitation of ultraviolet radiation. The inks exhibit a peak of absorbance of between about 400 nm and about 600 nm, and an absorbance of the ink diluted by 100 times and measured in 1 mm cell of more than about 0.6. The preferred inks are characterized by a color of the ink diluted by 100 times with water and measured in 1 mm cell is t L*: about 80±10, a*: about 45±20, b*: about 20±35 and a color of the printed image of L*: about 65±10, a*: about 55±10, b*: about 5±20. Compositionally, the preferred inks are comprised of a dye selected from the group consisting of C.I. Acid Red 52, C.I. Acid Red 87 and C.I. Acid Red 92. In some preferred inks, the absorption coefficient to paper is between about 0 mL/m²sec^{1/2} and about 130 mL/m²sec^{1/2} by the measurement of the Bristow method.

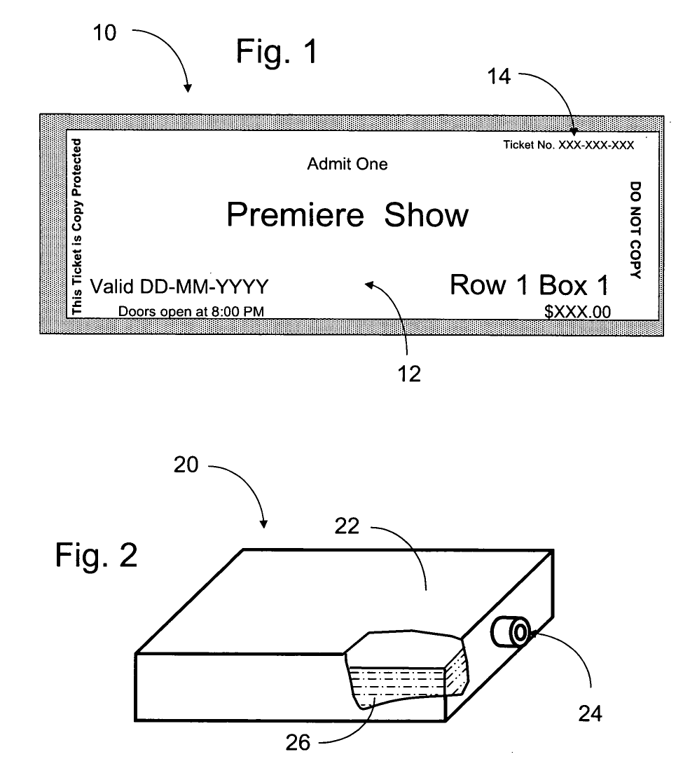

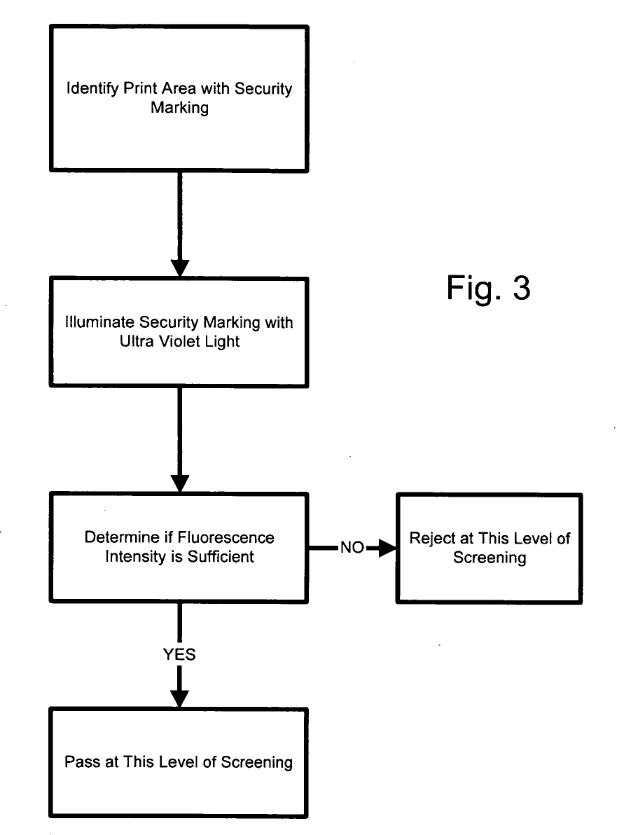

### CROSS REFERENCE TO RELATED APPLICATION

This application is related to a copending application of the same inventors filed on equal date, and entitled Red Fluorescent Inks That Change Properties After Being Processed, Process And Secure Articles (Attorney Docket No. G-228), the disclosure of which is incorporated herein by reference.

### BACKGROUND

The invention relates to new fluorescent red inks for ink-jet printing. The inks provide red printed images with high-intensity fluorescence emission. The printed images can be used for high density bar code (2D bar codes) having high readability in a distinctive red coloration.

High readability is essential for high-density bar codes such as those known as 2D bar codes. However, high readability for fluorescent red inks is generally diminished as optical density is increased. It has been especially difficult to prepare fluorescent red inks suitable for ink-jet printing that can also provide high machine readability. The problems of producing a red ink-jet fluorescent ink suitable for replaceable ink cartridges that must undergo long periods of shelf storage and intermittent use are more complex than might initially appear. To a great extent, the properties that are needed are inconsistent with each other.

There are several ink-jet printing methods. In each, means are provided for ejecting ink droplets, and a portion or all of the ink droplets are sprayed onto a printing medium such as paper to perform printing. In one method droplets are formed by electrostatically drawing ink by use of piezoelectric elements. In another, means heat ink to form gas bubbles and eject ink by pressure provided by the bubbles. Inks should be suitable for both types of printing without sacrificing high optical density (dark visible image), intense fluorescence, good visible red color or print sharpness.

Water-based inks, which use water as a main solvent, have been developed increasingly for use in ink-jet printing. These inks must not clog ink nozzles at the tip of a printhead or an ink channel of an ink-jet printer, to allow stable ink ejection, and to produce a bright-colored and high-density printed image. Water-soluble dyes are typically used as coloring agents for the water-based ink-jet inks. It is important to identify the water-soluble dyes that dissolve completely in water and reduce impurities to amounts that assure that the tip of the printhead or the ink channel of the ink-jet printer will not clog, ensuring the production of bright-colored high-density prints. Thus, this is another criterion that makes the search for suitable dyes for these specialized inks more difficult.

If a fluorescent ink is to be used in an ink-jet printer, the fluorescent ink must have certain physical properties, such as a certain viscosity and a specified surface tension. The viscosity of the liquid inks used in current piezoelectric ink-jet printers is about 1.5 to about 20 centipoise (cps) and in the thermal ink-jet printer is lower (about 1 to about 5 cps). The desirable surface tension of liquid ink-jet printer inks should be between about 30 and about 45 dynes/cm. Desirably, the inks should have pH values above about 7.

It is important that ink-jet inks be formulated to counter any tendency to dry in the nozzles of the printer during operation of the printer and between operations of the printer. The long term solubility which affects the shelf life depends on the colorant's solubility in the solvent in various environmental conditions of temperature and humidity. The dyes that exhibit good water solubility often suffer from deficiency in water fastness and smear fastness on the generated prints. This compounds the difficulty in formulation because the inks that provide good readability generally contain a mixture of dyes to enhance visible contrast, e.g., by using one or more dyes with high absorbency values. This can have an adverse effect on the fluorescent signal (lowering the signal) of the prints due to quenching or other phenomena. The use of dyes to enhance visible contrast can also adversely affect the desired red color. It is necessary to have an ink with the correct visible color, high machine readability in the visible spectrum and intense fluorescence.

Many red inks displaying fluorescence are so modified by additional ingredients and supplementary dyes or the like that they fail to exhibit a clearly red color. Often, the color appears to have a hue inconsistent with the impression of red that is expected for such images. Desirably, the red ink should have a red color as defined by a standard test and print images that are also red by standard test. For example, the ink (diluted per standard test protocol) should have a color defined as red by colorimetric spectrometer (e.g., SC-T produced by Suga Test Instrument Co., Ltd), i.e., L*=about 70 to about 90, a*=about 25 to about 65, b*=about −15 to about 55. Also, by way of example, the printed image should have a color defined as red by colorimetric spectrometer, i.e., L*=about 55 to about 75, a*=about 45 to about 65, b*=about −15 to about 25. These results are according to CIE (International Commission on Illumination) standards established in 1964. The L* value is a measure of light and dark, while the a* and b* values are a measure of the color. Neutral color would be represented by a*=0 and b*=0, with the color shifting from gray to black as the L value decreases. Frequently, the formulation of red inks for use with ink-jet printing to provide fluorescent images do not retain the basic essential of good red color.

In addition to the above, ink-jet inks are typically formulated to be rapidly absorbed to provide a dry touch immediately following printing. However, fast penetrating inks often display decreased optical density proportional with the ink penetration. This effect must be compensated for in order to achieve good print quality. This further complicates the formulation of inks to provide both high visible contrast of the correct color and a strong fluorescent signal.

The formulation of ink-jet inks suitable for printing two-dimensional (2D) bar codes requires good optical density to provide visual definition as needed to convey large amounts of information in a relatively small space. The information density of 2D bar codes is high, and readability must be correspondingly high to best take advantage of this image format. Various two-dimensional barcode formats exist, such as Data Matrix 2D bar codes based on the AIM International Technical Specification—International Symbology Specification—marketed by AIM International, Inc; or PDF-417 symbology based on the Uniform Symbology Specification PDF-417 by AIM USA. An exemplary apparatus and method for printing two-dimensional bar codes is described in U.S. Pat. No. 6,631,012, which is hereby incorporated by reference in its entirety. There are other applications and systems which also require the combination of high optical density and strong fluorescence where ink-jet printing would be a desired means of printing.

There is a need for improved fluorescent inks for ink-jet printing, which inks must provide optically-dense red printed images of defined red color with high-intensity fluorescence emission that exhibit sufficiently low print growth and infiltration such that they can be used for high density bar codes (e.g., 2D bar codes) having high readability.

### SUMMARY

It is an object of invention to provide new fluorescent red inks suitable for ink-jet printing.

It is a more specific object of the invention to provide new ink-jet printing inks that can provide red printed images with high-intensity fluorescence emission.

It is another object of the invention to provide new fluorescent inks for ink-jet printing capable of printing images that can be used for high density bar code applications (2D bar codes) having high readability.

It is another object of the invention to provide inks that can be used to print images that can be inspected at a first level in normal daylight and then at another, such as with an ultraviolet lamp, both with low error rates.

It is yet another object of the invention to provide new fluorescent inks for ink-jet printing capable of printing images wherein the peak of fluorescent intensity of the printed images is within a range from about 500 nm to about 700 nm in wavelength when the ink is excited by 254 nm ultraviolet radiation.

It is still another object of the invention to provide new fluorescent inks for ink-jet printing capable of printing sharp red images wherein the peak of fluorescent intensity of the ink, which is diluted by water by 100 times, is more than about 70.

It is another object of the invention to provide new fluorescent inks for ink-jet printing capable of printing visibly red images wherein the peak of absorbance of the ink, which is diluted by water by 100 times, was more than about 0.6.

It is another object of the invention to provide new fluorescent inks for ink-jet printing red images where the print growth is small.

It is another object of the invention to provide new fluorescent inks for ink-jet printing where the absorption coefficient is small.

It is yet another and more specific object of the invention to provide new ink-jet inks capable of forming optically-dense red printed images of defined red color with high-intensity fluorescence emission that exhibit sufficiently low print growth and infiltration such that they can be used for high density bar codes (e.g., 2D bar codes) having high readability.

These and other objects are accomplished by the invention, which provides ink compositions, processes for using them and the resulting products.

The inks of the invention are aqueous and capable of producing machine-readable markings exhibiting fluorescence when exposed to fluorescent-exciting radiation, and exhibit a peak of fluorescence between about 500 nm and about 700 nm by excitation of ultraviolet radiation, a fluorescent strength of the ink diluted by 100 times of more than about 70 by excitation of ultraviolet radiation, a peak of absorbance of between about 400 nm and about 600 nm, and an absorbance of the ink diluted by 100 times and measured in 1 mm cell of more than about 0.6. The preferred inks are characterized by a color of the ink diluted by 100 times with water and measured in 1 mm cell is L*: about 80±10, a*: about 45±20, b*: about 20±35. Compositionally, the preferred inks are comprised of a dye selected from the group consisting of C.I. Acid Red 52, C.I. Acid Red 87 and C.I. Acid Red 92. In some preferred inks, the fluorescent strength of about 0.1 wt % dye solution is more than about 70 by excitation with ultraviolet radiation. In other preferred inks, the absorption coefficient to paper is between about 0 mL/m² sec^{1/2} and about 130 mL/m² sec^{1/2} by the measurement of the Bristow method.

From another perspective, the inks of the invention exhibit an absorption coefficient to the paper of between about 0 mL/m²sec^{1/2} and about 130 mL/m²sec^{1/2} by the measurement of the Bristow method, the fluorescent strength of the print which has about 5,400,000 pl/inch² ink volume is more than about 130 by excitation of ultraviolet radiation, the peak of fluorescence exists between about 500 nm and about 700 nm by excitation of ultraviolet radiation, and the color of print is L*: about 65±10, a*: about 55±10, b*: about 5±20.

From another perspective, the inks of the invention exhibit an absorption coefficient to the paper is between about 0 mL/m²sec^{1/2} and about 130 mL/m²sec^{1/2} by the measurement of the Bristow method, the fluorescent strength of a printed image of 100% coverage by 600 dot by 300 dot/inch² of printing density, wherein the volume of 1 dot is about 30 pl, is more than about 130 by excitation of ultraviolet radiation, and the peak of fluorescence exists between about 500 nm and about 700 nm by excitation of ultraviolet radiation, and the symbol contrast of 2-dimension printed by 600 dot by 300 dot/inch² of printing density where the volume of 1 dot is about 30 pl, is between about 40% and about 100%.

In one aspect, the process of the invention comprises: printing an image having visible, fluorescent and phosphorescent components by providing an ink-jet printer with an ink as described, and printing an image with the ink on a suitable substrate.

In another process aspect, the invention provides printed images having a visible red image of color L*: about 65±10, a* about:55±10, b*: about 5±20, and a fluorescent image wherein the peak of fluorescence exists between about 500 nm and about 700 nm by excitation of ultraviolet radiation.

Other preferred aspects are described below.

### DETAILED DESCRIPTION

The invention relates to new red fluorescent inks for ink-jet printing. The inks provide red printed images with high-intensity fluorescence emission and can be used for high density bar code (e.g., 2D bar codes) having high readability.

The inks of the invention have been identified through testing to find fluorescent red ink formulations for ink-jet printing to provide a unique combination of properties which is important to provide red printed images having good machine readability high-density images on a variety of print substrates. The inks of the invention have been found to be practical by virtue of the following summary of important ink properties, when tested as will be described from ink samples diluted 100 times with water. Thus, the preferred diluted solutions of the inks of the invention have the following basic properties, where the tests are described in the Examples below:

| | |
|---|---|
| Properties | Ranges of effective Values |

| Fluorescence | | ×100 | > about 70 |
|---|---|---|---|
| | | | (about 500-about 700 nm) |
| Absorbance | | ×100 | > about 0.6 |
| | | 1 mm cell | (about 400-about 600 nm) |
| Color | L* | ×100 | L*: about 80 ± 10 |
| | a* | 1 mm cell | a*: about 45 ± 20 |
| | b* | | b*: about 20 ± 35 |

| | |
|---|---|
| Absorption coefficient | about 0-about 130 |

The preferred inks prepared according to the invention will provide printed images having the following properties, where the tests are described in the Examples below:

| Fluorescence | | > about 130 |
|---|---|---|
| | | (about 500-about 700 nm) |
| Color | L* | L*: about 65 ± 10 |
| | a* | a*: about 55 ± 10 |
| | b* | b*: about 5 ± 20 |

| | |
|---|---|
| Symbol Contrast (%) | about 40-about 100 |
| Print Growth x | about −0.1-about 0.26 |
| Print Growth y | about −0.1-about 0.26 |
| Absorption coefficient | about 0-about 130 |

The fluorescent inks of the invention are especially formulated for ink-jet printing and exhibit viscosities and surface tension characteristics effective for this purpose. If the fluorescent ink is to be used in current piezoelectric ink-jet printers the viscosity will preferably be within the range of from about 1.5 to about 20 centipoise, and if it is to be used in a current thermal ink-jet printer it is lower, e.g., from about 1 to about 5 cps. The desirable surface tension of liquid ink-jet printer inks should be between about 30 and about 45 dynes/cm. Desirably, the inks should have pH values above about 7, preferably within the range of from about 7.5 to about 9.0.

In general, the inks of the invention meet the criteria of having a peak of fluorescence of the ink exists between about 500 nm and about 700 nm by excitation of ultraviolet radiation. Also, the fluorescent strength of the ink diluted by 100 times is more than about 70 by excitation of ultraviolet radiation, and the peaktop of absorbance exists between about 400 nm and about 600 nm, and the absorbance of the ink diluted by 100 times and measured in 1 mm cell is more than about 0.6. The examples below illustrate inks meeting the criteria of the invention that are comprised of a dye selected from the group consisting of C.I. Acid Red 52, C.I. Acid Red 87, C.I. Acid Red 92 and C.I. Basic Red 1; water; and organic, polar solvent(s). Auxiliary dyes can also be employed as long as they do not adversely affect the important properties of the inks. The examples below illustrate the use of C.I. Acid Yellow 73 in combination with C.I. Acid Red 52, C.I. Acid Red 87 and C.I. Acid Red 92.

The solvent system of these inks will typically comprise organic polar solvents and water. The organic polar solvents are all soluble in water. The solvent's polarity is a function of the solvating properties, which in turn is a measure of the sum of the molecular properties responsible for the interaction between the solute and solvent. The water used is preferably super pure, e.g., which means it contains no impurities that have possibilities of causing the precipitation and the agglomeration of the ink, and causing nozzle clogging. It is also important that the dyes be essentially free of impurities. Water will typically comprise a majority of the formulations, e.g., about 55 to about 90 weight percent, while the organic polar solvents will typically comprise up to about half of the solvent system, e.g., from about 10 to about 45 weight percent of the solvent system.

Organic solvent additives, sometimes referred to as glycol humectants, are useful because of their water absorbing hygroscopic properties namely. Among this group are ethylene glycol, propylene glycol, diethylene glycol, polyethylene glycol (PEG) and glycerin. Another category of useful humectants includes materials such as powerful surfactant humectants which prevent drying of the ink in ink-jet nozzles when exposed to air and an example are the Nuosperse® surfactants (e.g., ethoxylated oleyl alcohol, alkyl polyglycol, tridecyl alcohol ethoxylated, phosphated sodium salt). Another series of solvents were selected based upon a high dipole moment and high hydrogen bonding solubility parameters such as 2-pyrolidone, N-methyl pyrolidone, sulfolane, gamma butylactone, 4-methylmorpholine-n-oxide and dimethylsulfoxide. All these solvents are nonvolatile, polar and hygroscopic and dissolve in water causing an increase in viscosity. The glycol ether type solvents can be selected depending on the environment because they can act as a bridging agent with various polarity resins or other components and assume polar or non-polar nature depending upon the environment. The glycol ethers can increase penetration into paper substrates and also aids in fixing the ink to the paper thus improving water fastness. The examples of this type solvent are propylene glycol butyl ether, diethylene glycol butyl ether, diethylene glycol propyl ether, triethylene glycol ethyl ether and triethylene glycol mono-n-butyl ether.

It is a distinct advantage of the red inks of the invention that they not only display fluorescence, they exhibit a clearly red color. The color of the ink before printing is desirably red and printed images exhibit a hue fully consistent with that expected for red for such images. Desirably, the red inks (diluted 100 times with water per standard test protocol) of the invention have a color defined as red by colorimetric spectrometer (e.g., UV-3100PC produced by Shimadzu Corporation), i.e., L*=about 70 to about 90, a*=about 25 to about 65, b*=about −15 to about 55. Equally important, the printed images made from these inks will have a color defined as red by colorimetric spectrometer (e.g., SC-T produced by Suga Test Instrument Co., Ltd), i.e., L*=about 55 to about 75, a*=about 45 to about 65, b*=about −15 to about 25. These results are according to CIE (International Commission on Illumination) standards established in 1964. The L* value is a measure of light and dark, while the a* and b* values are a measure of the color. Neutral color would be represented by a*=0 and b*=0, with the color shifting from gray to black as the L value decreases. Frequently, the formulation of red inks for use with ink-jet printing to provide fluorescent images do not retain the basic essential of good red color. The test protocol is described in the examples below, but generally involves the light source is halogen lamp or deuterium lamp, and the cell is quartz cell.

It is important to the objects of the invention and an advantage of the inks provided that the printed images are not obscured by undue blurring or spreading. It is conventional to describe these properties in terms of an absorption coefficient to a paper substrate by the measurement by the Bristow method, which is defined as follows: the amount of the ink transferred to the paper is plotted as ordinate with respect to the square root of the absorption time as abscissa, so that an absorption curve is obtained. The gradient of a linear portion of the obtained absorption curve is measured, so that the absorption coefficient with respect to the ink is obtained. The inks of the invention yield images characterized by an absorption coefficient of between about 0 mL/m²sec^{1/2} and about 130 mL/m²sec^{1/2}. See ASTM D-5455-93 (2003).

Another important characteristic and advantage of the inks of the invention is that the fluorescent strength of a printed image of 100% coverage by 600 dot by 300 dot/inch² of printing density wherein the volume of 1 dot is about 30 pl, is more than about 130 by excitation of ultraviolet radiation, and the peak of fluorescence exists between about 500 nm and about 700 nm by excitation of ultraviolet radiation, and the Symbol Contrast of 2-Dimension printed by 600 dot by 300 dot/inch² of printing density which the volume of 1 dot is about 30 pl (picoliter), is between about 40% and about 100%. Symbol contrast for DataMatrix symbols is a measure of the difference between dark cells and light cells and follows the recommended DataMatrix specification. Contrast is then a measurement of the difference between the average lightest 10% of the pixels in the image and the average of the darkest 10% of the pixels. (see, for example, INTEGRA-9500 Appendix A: DataMatrix Parameters: 110705, which is incorporated herein by reference.) From another perspective, it is an advantage of preferred inks that they exhibit fluorescent strength values of the print which has about 5,400,000 pl/inch² ink volume of more than about 130 by excitation of ultraviolet radiation. These properties are of special advantage in achieving the objects of the invention, as is the ability to control print growth. Preferably, printed images exhibit a print growth value, x and y, of 2-Dimension printed by 600 dot by dot 300/inch² of printing density wherein the volume of 1 dot is about 30 pl, is between about −0.1 and about 0.26. Print growth is analyzed by the Data Matrix verification system (DMx Verifier+TM produced by RVSI Acuity CiMatrix).

It is an advantage of preferred aspects of the invention that the symbol contrast of 2-dimension image printed by 600 dot by 300 dot/inch² of printing density is between about 40% and about 100%, and the print growth value, x and y, of 2-dimension printed by 300 dot by 300 dot/inch² of printing density wherein the volume of 1 dot is about 30 pl, is between about −0.1 and about 0.26.

The following examples are presented to further illustrate and explain the invention and are not to be taken as limiting in any regard. Unless otherwise indicated, all parts and percentages are by weight.

### EXAMPLES

A series of inks were prepared according to the invention and compared to other inks of similar formulation but not meeting the criteria of the invention. The inks have the formulations indicated in the following Table 1:

TABLE 1
Composition of Inks

| | | | | | Comparative | | |
|---|---|---|---|---|---|---|---|
| | Invention | | | | Examples | | |
| | 1 | 2 | 3 | 4 | 5 | 6 | 7 |
| C.I. Acid Red 52 | 0.4 | — | — | — | 0.2 | — | — |
| C.I. Acid Red 87 | — | — | 3.5 | — | — | — | — |
| C.I. Acid Red 92 | — | 1.2 | — | — | — | — | — |
| C.I. Basic Red 1 | — | — | — | 1.0 | — | — | — |
| C.I. Acid Red 289 | — | — | — | — | — | 1.2 | 0.4 |
| C.I. Acid Yellow 73 | 1.5 | 0.8 | 0.2 | — | — | 0.8 | — |
| Super pure water | 68.1 | 68.0 | 66.3 | 69.0 | 69.8 | 68.0 | 69.6 |
| Polyethylene Glycol | 10.0 | 10.0 | 10.0 | 10.0 | 10.0 | 10.0 | 10.0 |
| (M.W. 200) | | | | | | | |
| 2-Pyrrolidone | 17.0 | 17.0 | 17.0 | 17.0 | 17.0 | 17.0 | 17.0 |
| Triethylene Glycol | 3.0 | 3.0 | 3.0 | 3.0 | 3.0 | 3.0 | 3.0 |
| Mono Butyl Ether | | | | | | | |
| (BTG) | | | | | | | |
| Total | 100.0 | 100.0 | 100.0 | 100.0 | 100.0 | 100.0 | 100.0 |

Each ink was diluted by water by 100 times for testing the properties of fluorescence, absorbance and color, with the results reported below in Table 2.

The fluorescence spectrum of each of the diluted ink was observed with a fluorescence spectrophotometer (F-4500 produced by Hitachi High-Technologies Corporation). The fluorescence spectrum was observed in range from 500 nm to 700 nm in wavelength. The wavelength of excitation light was 254 nm, and the fluorescence of the diluted ink was in a 1 mm-thick quartz cell.

The color of the diluted ink was measured with an ultraviolet-visible spectrometer (UV-3100PC produced by Shimadzu Corporation). Here also, the diluted ink was held in a 1 mm-thick quartz cell and the color of the diluted ink was measured in a range from 200 nm to 800 nm.

The absorbance of the diluted ink was measured with an ultraviolet-visible spectrometer (UV-3100PC produced by Shimadzu Corporation). The absorbance was measured in a range from 400 nm to 600 nm in wavelength and was measured while the diluted ink was in a 1 mm-thick quartz cell.

TABLE 2
Properties of the Ink

| | | | Invention | | | | Comparative Examples | | |
|---|---|---|---|---|---|---|---|---|---|
| | | | 1 | 2 | 3 | 4 | 5 | 6 | 7 |
| Fluorescence | | x100 | 136(583 nm) | 148(555 nm) | 159(541 nm) | 321(555 nm) | 76□583 nm) | no peak | no peak |
| Absorbance | | x100 | 0.784(566 nm) | 1.002(538 nm) | 4.470(517 nm) | 1.311(526 nm) | 0.399(566 nm) | 1.348(527 nm) | 0.491(527 nm) |
| | | 1 mmcell | 1.916(488 nm) | 0.969(488 nm) | — | 1.165(501 nm)) | — | 1.589(492 nm) | — |
| Color | L* | x100 | 75.7 | 81.2 | 84.0 | 80.8 | 88.5 | 77.0 | 89.2 |
| | a* | 1 mmcell | 29.2 | 41.0 | 44.3 | 58.9 | 21.2 | 55.2 | 33.6 |
| | b* | | 48.7 | 37.5 | 31.5 | −9.5 | −17.4 | 23.2 | −11.6 |

| | | | | | | | |
|---|---|---|---|---|---|---|---|
| Absorption coefficient | 88.8 | 88.3 | 99.6 | 93.1 | 103 | 107 | 107 |

Printed images were prepared using the inks and tested, and the results are summarized below in Table 3.

Non-diluted ink was ejected onto envelope (Signet envelopes manufactured by UNISOURCE) with a multifunction device (MFC-5100J produced by Brother Industries, Ltd.) to obtain the recording sample. The print pattern was 100% coated print and 2D barcode.

The color of recording samples was measured with a colorimetric spectrometer (SC-T produced by Suga Test Instrument Co., Ltd). The light source was standard light source D₆₅. The view angle was 10 degree. Non-diluted ink was ejected onto envelope (Signet envelopes manufactured by UNISOURCE) with a multifunction device (MFC-5100J produced by Brother Industries, Ltd.) to obtain the recording sample.

The print growth of the recording sample was analyzed by the Data Matrix verification system (DMx Verifier+TM produced by RVSI Acuity CiMatrix). Non-diluted ink was ejected onto envelope (Signet envelopes manufactured by UNISOURCE) with a multifunction device (MFC-5100J produced by Brother Industries, Ltd.) to obtain the recording sample.

The absorption coefficient of the ink onto envelope (Signet envelopes manufactured by UNISOURCE) was measured by Bristow method (Measuring equipment was “L” produced by Toyo Seiki Kogyo). The slit width of head box was 1.0 mm. The movement speed of paper was changed from 0.5 mm/sec to 250 mm/sec.

TABLE 3
Quality of Prints

| | | Invention | | | | Comparative Examples | | |
|---|---|---|---|---|---|---|---|---|
| | | 1 | 2 | 3 | 4 | 5 | 6 | 7 |
| Fluorescence | | 347(598 nm) | 367(589 nm) | 165(564 nm) | 254(571 nm) | 678(597 nm) | 83(573 nm) | 103(573 nm) |
| Color | L* | 59.7 | 64.6 | 67.8 | 66.2 | 76.6 | 62.8 | 73.4 |
| | a* | 53.7 | 57.2 | 59.1 | 61.8 | 38.8 | 57.9 | 49.7 |
| | b* | 16.4 | 14.3 | 18.1 | −9.4 | −20.8 | 12.5 | −17.2 |

| | | | | | | | |
|---|---|---|---|---|---|---|---|
| Symbol Contrast(%) | 56 | 49 | 46 | 43 | 28 | 51 | 34 |
| Print Growth x | 0.11 | 0.11 | 0.09 | 0.11 | 0.11 | 0.11 | 0.11 |
| Print Growth y | 0.12 | 0.11 | 0.12 | 0.12 | 0.11 | 0.12 | 0.10 |
| Absorption coefficient | 88.8 | 88.3 | 99.6 | 93.1 | 103 | 107 | 107 |

The following conclusions can be drawn from the above examples:
Examples 1 to 4, which relate to the invention, each show good results.
The fluorescent intensity of inks of the invention was strong, more than 70 at the peak (500-700 nm).
The absorbance of ink was dark, more than 0.6 at the peak (400-600 nm).
The color of the ink was red: L*=70 to 90, a*=25 to 65, b*=−15 to 55.
The fluorescent intensity of the recording samples was strong, more than 130 at the peak (500-700 nm).
The color of the recording sample was red: L*=55 to 75, a*=45 to 65, b*=−15 to 25.
The print growth of the recording sample was small, from −0.1 to 0.26.
The absorption coefficient of the ink was small, from 0 to 130.

In comparison:
Comparative Example 5 shows bad results in term of the absorbance and the color.
Comparative Example 6 shows a bad result in term of the fluorescent intensity.
And, Comparative Example 7 shows bad results in term of the fluorescent intensity, the absorbance and the color.
Therefore, the inks of the invention, as illustrated in Examples 1 to 4, can be used for high density bar codes (2D bar codes) having high readability while the inks of the Comparative Examples cannot.

The above description is intended to enable the person skilled in the art to practice the invention. It is not intended to detail all of the possible modifications and variations, which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

We claim:

1. A fluorescent ink for ink-jet printing, comprising water soluble dyes, water and solvent, wherein:
the peak of fluorescence of the ink exists between 500 nm and 700 nm by excitation of ultraviolet radiation,
the fluorescent strength of the ink diluted by 100 times is more than 70 by excitation of ultraviolet radiation,
the peak of absorbance exists between 400 nm and 600 nm, and
the absorbance of the ink diluted by 100 times and measured in 1 mm cell is more than 0.6.

2. A fluorescent red ink for ink-jet printing according claim 1, wherein the fluorescent strength of 0.1 wt % dye solution is more than about 70 by excitation of ultraviolet radiation.

3. A fluorescent ink for ink-jet printing according claim 2, wherein the dye is selected from the group consisting of C.I. Acid Red 52, C.I. Acid Red 87 and C.I. Acid Red 92.

4. A fluorescent ink for ink-jet printing according claim 1, wherein the color of the ink which is diluted with water by 100 times and is measured in 1 mm cell is L*:80±10, a*:45±20, b*:20±35.

5. A fluorescent ink for ink-jet printing according claim 1, wherein the absorption coefficient to the paper is between about 0 mL/m²sec^{1/2} and about 130 mL/m²sec^{1/2} by the measurement of the Bristow method.

6. A fluorescent ink for ink-jet printing wherein:
the absorption coefficient to the paper is between about 0 mL/m²sec^{1/2} and about 130 mL/m²sec^{1/2} by the measurement of the Bristow method,
the fluorescent strength of the printed part of 100% coverage by 600 dot by 300 dot/inch² of printing density, where the volume of 1 dot is 30 pl, is more than 130 by excitation of ultraviolet radiation,
the peak of fluorescence exists between 500 nm and 700 nm by excitation of ultraviolet radiation, and
the symbol contrast of 2-dimension printed by 600 dot by 300 dot/inch² of printing density, where the volume of 1 dot is about 30 pl, is between about 40% and 100%.

7. A fluorescent ink for ink-jet printing according claim 6, wherein the fluorescent strength of 0.1 wt % dye solution is more than about 70 by excitation of ultraviolet radiation.

8. A fluorescent ink for ink-jet printing according claim 7, wherein the dye is selected from the group consisting of C.I. Acid Red 52, C.I. Acid Red 87 and C.I. Acid Red 92.

9. A fluorescent ink for ink-jet printing according claim 6, wherein the print growth value, x and y, of 2-dimension printed by 600 dot by 300 dot/inch² of printing density where the volume of 1 dot is about 30 pl, is between about −0.1 and about 0.26.

10. A fluorescent ink for ink-jet printing according claim 6, wherein the color of the print is L*:65±10, a*:55±10, b*:5±20.

11. A fluorescent ink for ink-jet printing wherein:
the absorption coefficient to the paper is between about 0 mL/m²sec^{1/2} and about 130 mL/m² sec^{1/2} by the measurement of the Bristow method,
the fluorescent strength of the print which has about 5,400,000 pl/inch² ink volume is more than 130 by excitation of ultraviolet radiation,
the peak of fluorescence exists between 500 nm and 700 nm by excitation of ultraviolet radiation, and
the color of print is L*:65±10, a*:55±10, b*:5±20.

12. A fluorescent ink for ink-jet printing according claim 11, wherein the fluorescent strength of 0.1 wt % dye solution is more than about 70 by excitation of ultraviolet radiation.

13. A fluorescent ink for ink-jet printing according claim 12, wherein the dye is selected from the group consisting of C.I. Acid Red 52, C.I. Acid Red 87 and C.I. Acid Red 92.

14. A fluorescent ink for ink-jet printing according claim 11, wherein the symbol contrast of 2-dimension printed by 600 dot by 300 dot/inch² of printing density is between about 40% and 100%, and the print growth value, x and y, of 2-dimension printed by 300 dot by 300 dot/inch² of printing density where the volume of 1 dot is about 30 pl, is between about −0.1 and about 0.26.

15. A process for printing an image having visible, fluorescent and phosphorescent components comprising: providing an ink-jet printer with an ink as described in claim 1, and printing an image with the ink on a suitable substrate.

16. A process for printing an image having visible, fluorescent and phosphorescent components comprising: providing an ink-jet printer with an ink as described in claim 6, and printing an image with the ink on a suitable substrate.

17. A process for printing an image having visible, fluorescent and phosphorescent components comprising: providing an ink-jet printer with an ink as described in claim 11, and printing an image with the ink on a suitable substrate.

18. A printed image prepared by the process of claim 15.

19. A printed image prepared by the process of claim 16

20. A printed image prepared by the process of claim 17
